(19) United States
(12) Patent Application Publication
(10) Pub. No.: US 2026/0085937 A1
(43) Pub. Date: Mar. 26, 2026

(54) MACHINE LEARNING FOR SELECTING FROM POSSIBLE LOCATIONS

(71) Applicant: Capital One Services, LLC, McLean, VA (US)

(72) Inventors: James A. LEWIS, Dallas, TX (US); Mohamed SECK, Aubrey, TX (US); Krystan R. FRANZEN, Mechanicsville, VA (US)

(21) Appl. No.: 18/897,599

(22) Filed: Sep. 26, 2024

(51) Int. Cl. G01C 21/34; G06F 16/28; G06F 16/9535; H04W 4/029

(52) U.S. Cl. CPC G01C 21/3407; G06F 16/289; G06F 16/9535; H04W 4/029

(57) ABSTRACT

In some implementations, a user device may transmit, to a selection system, an indication of at least one object. The user device may transmit, to the selection system, an indication of a plurality of possible accounts that are associated with a user of the user device. The user device may transmit, to the selection system, an indication of a location. The user device may receive, from the selection system, an identifier of a selected location, from the plurality of possible locations, and an identifier of a selected account, from the plurality of possible accounts, based on application of machine learning using the indication of at least one object, the indication of the location, and the indication of the plurality of possible accounts.

### BACKGROUND

Determining a location where an object may be acquired is a complex problem. For example, a model may minimize a combination of distance and cost in order to select the location.

### SUMMARY

Some implementations described herein relate to a system for using machine learning to select from a plurality of possible locations. The system may include one or more memories and one or more processors communicatively coupled to the one or more memories. The one or more processors may be configured to receive, from a user device, an indication of at least one object. The one or more processors may be configured to determine, using an object database, the plurality of possible locations, wherein the plurality of possible locations are associated with the at least one object. The one or more processors may be configured to communicate with a first set of web functions, associated with the plurality of possible locations, to receive a first plurality of data structures representing location information associated with the at least one object. The one or more processors may be configured to determine, using a user database, a plurality of possible accounts that are associated with a user of the user device. The one or more processors may be configured to communicate with a second set of web functions, associated with the plurality of possible accounts, to receive a second plurality of data structures representing terms associated with the plurality of possible accounts. The one or more processors may be configured to receive, from the user device, an indication of a current location associated with the user device. The one or more processors may be configured to transmit, to a traffic data source, a request for traffic information based on the current location and the plurality of possible locations. The one or more processors may be configured to receive, from the traffic data source, the traffic information in response to the request. The one or more processors may be configured to provide the first plurality of data structures, the second plurality of data structures, and the traffic information to a machine learning model to receive an identifier of a selected location, from the plurality of possible locations, and an identifier of a selected account, from the plurality of possible accounts. The one or more processors may be configured to output an indication of the selected location and an indication of the selected account to the user device. The one or more processors may be configured to receive, from the user device, an acceptance of the selected location. The one or more processors may be configured to output, to the user device, directions to the selected location from the current location.

Some implementations described herein relate to a method of using machine learning to select from a plurality of possible locations. The method may include transmitting, from a user device and to a selection system, an indication of at least one object. The method may include transmitting, from the user device and to the selection system, an indication of a plurality of possible accounts that are associated with a user of the user device. The method may include transmitting, from the user device and to the selection system, an indication of a location. The method may include receiving, from the selection system and at the user device, an identifier of a selected location, from the plurality of possible locations, and an identifier of a selected account, from the plurality of possible accounts, based on application of machine learning using the indication of at least one object, the indication of the location, and the indication of the plurality of possible accounts.

Some implementations described herein relate to a non-transitory computer-readable medium that stores a set of instructions for using machine learning to select from a plurality of possible locations. The set of instructions, when executed by one or more processors of a device, may cause the device to receive, from a user device, a request indicating at least one object. The set of instructions, when executed by one or more processors of the device, may cause the device to receive an indication of the plurality of possible locations, wherein the plurality of possible locations are associated with the at least one object. The set of instructions, when executed by one or more processors of the device, may cause the device to receive, for each possible location in the plurality of possible locations, location information associated with the at least one object. The set of instructions, when executed by one or more processors of the device, may cause the device to receive an indication of a plurality of possible accounts that are associated with a user of the user device. The set of instructions, when executed by one or more processors of the device, may cause the device to receive, for each possible account in the plurality of possible accounts, terms associated with the plurality of possible accounts. The set of instructions, when executed by one or more processors of the device, may cause the device to receive, from the user device, an indication of a starting location. The set of instructions, when executed by one or more processors of the device, may cause the device to receive traffic information based on the starting location, the plurality of possible locations, and a time associated with the request. The set of instructions, when executed by one or more processors of the device, may cause the device to provide the location information, the terms, and the traffic information to a machine learning model to receive an identifier of a selected location, from the plurality of possible locations, and an identifier of a selected account, from the plurality of possible accounts. The set of instructions, when executed by one or more processors of the device, may cause the device to output an indication of the selected location and an indication of the selected account to the user device.

### BRIEF DESCRIPTION OF THE DRAWINGS

FIGS. 1A-1E are diagrams of an example implementation relating to using machine learning for selecting from possible locations, in accordance with some embodiments of the present disclosure.

FIGS. 2A-2B are diagrams illustrating an example implementation relating to training and using a machine learning model in systems and/or methods described herein, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIGS. 5-6 are flowcharts of example processes relating to using machine learning for selecting from possible locations, in accordance with some embodiments of the present disclosure.

### DETAILED DESCRIPTION

The following detailed description of example implementations refers to the accompanying drawings. The same reference numbers in different drawings may identify the same or similar elements.

Determining a location where an object may be acquired is a complex problem. For example, location data about the object, as well as cost and inventory data, may be gathered to train a model. The model may minimize a combination of distance and cost in order to select the location. Based on the location, a user device may request directions to the location using a routing model. Therefore, significant power and processing resources are consumed by applying two models to select and route a user based on the object. Additionally, accuracy is reduced by selecting the location separately from selecting the route.

The user generally also selects an account to use for acquiring the object. For example, the user device may store a spreadsheet or another type of model that selects the account based on the object and/or the location. Therefore, additional power and processing resources are consumed by using the spreadsheet, and accuracy is further reduced by selecting the account separately from the location.

Some implementations described herein enable a machine learning model to select a location for an object and an account to use while using traffic information as a factor. As a result, power and processing resources are conserved as compared with using separate models to select the location, select the account, and route a user to the location. Additionally, accuracy is increased as compared with using separate models.

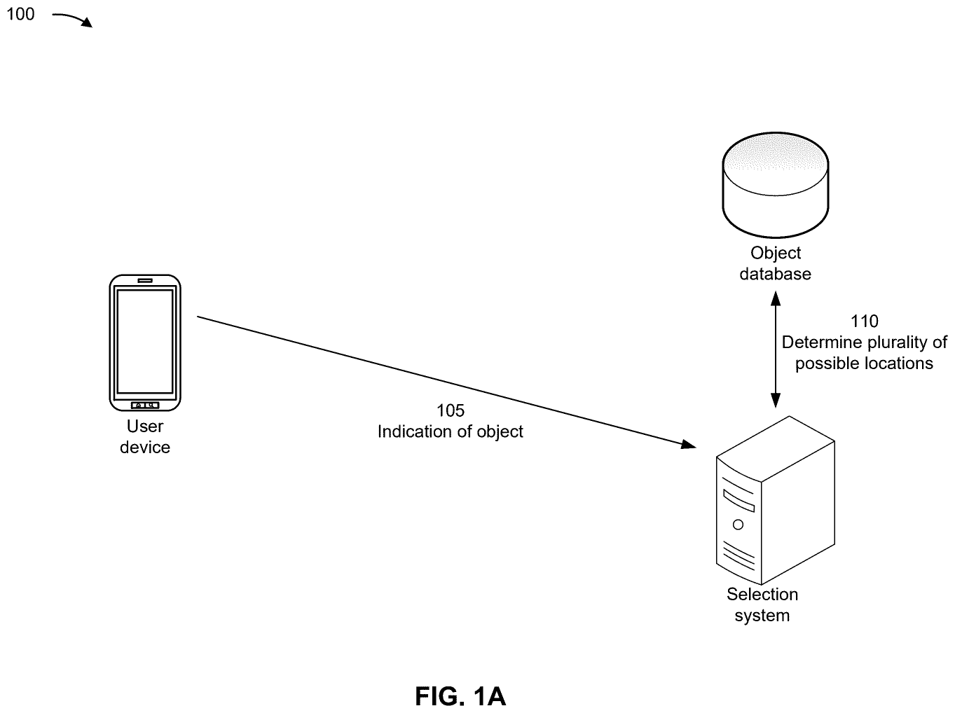

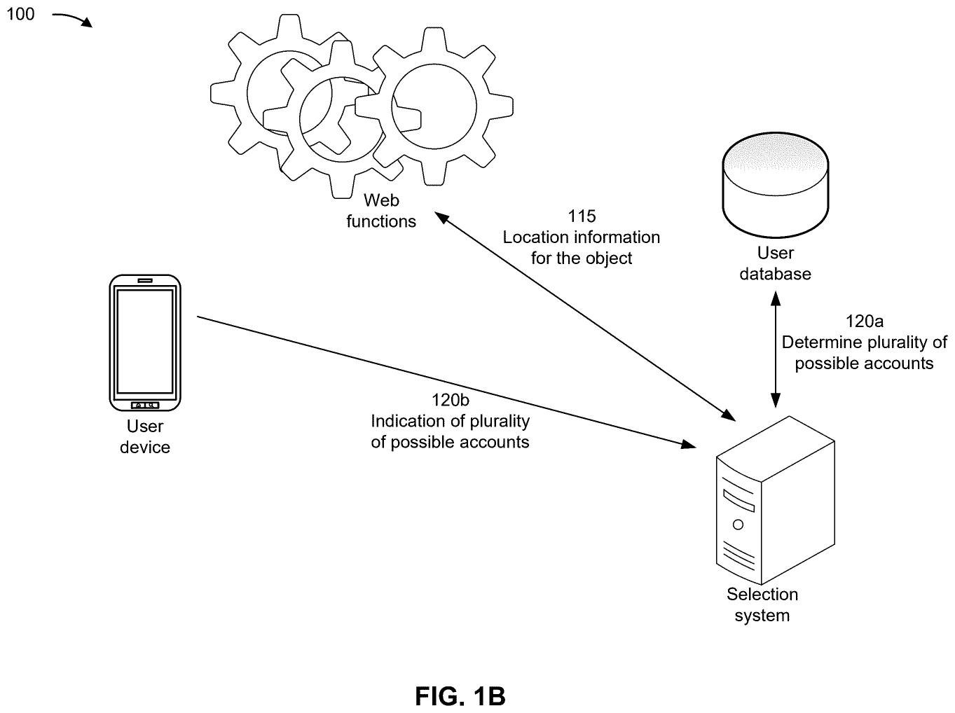

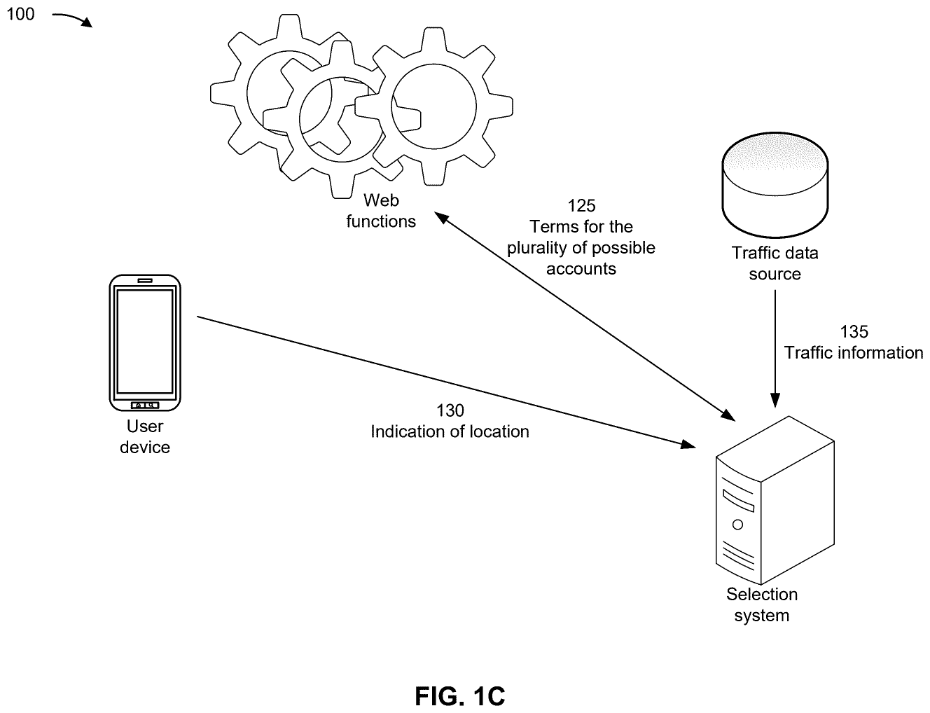

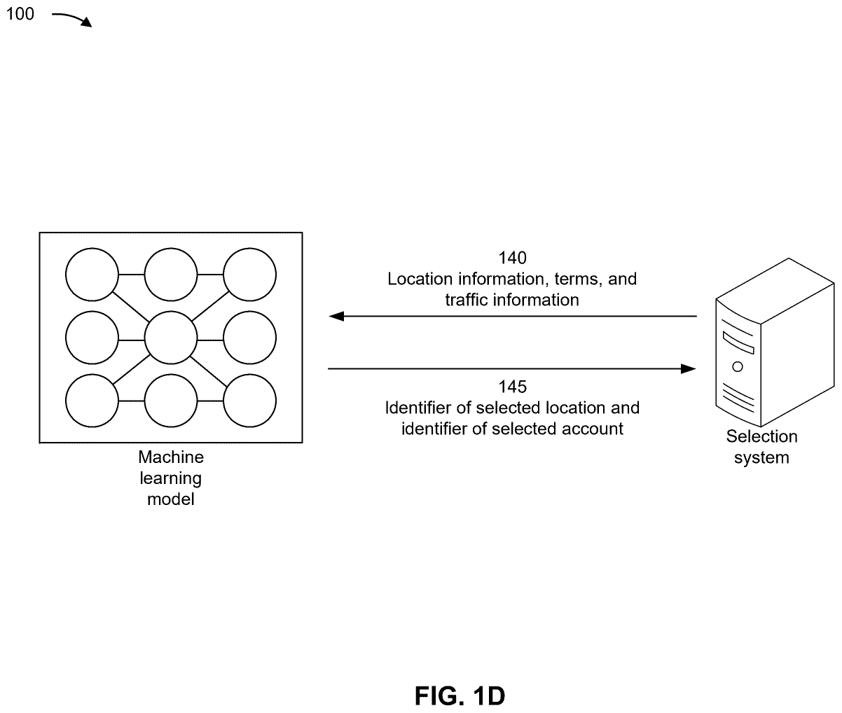

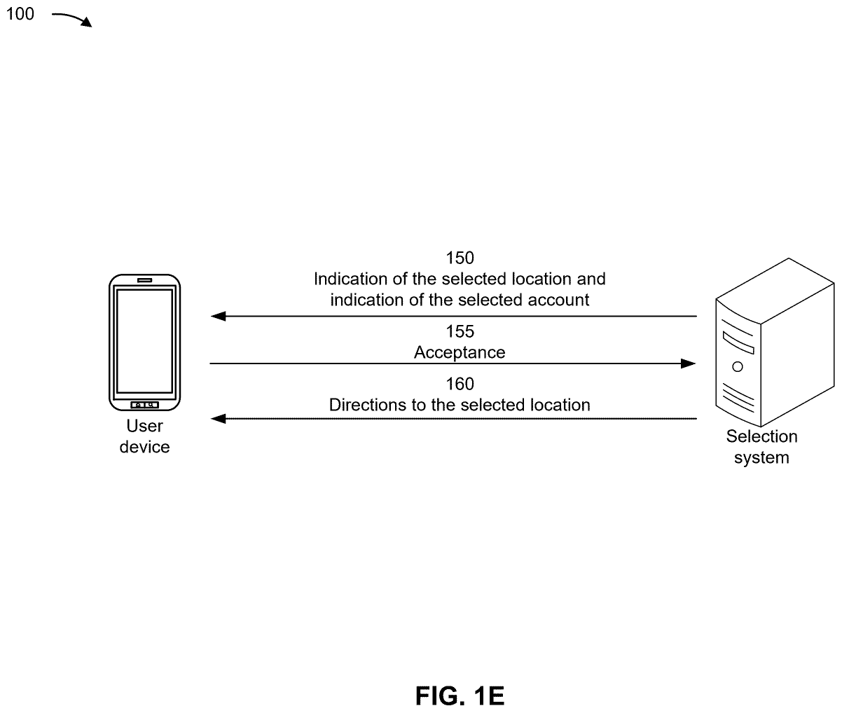

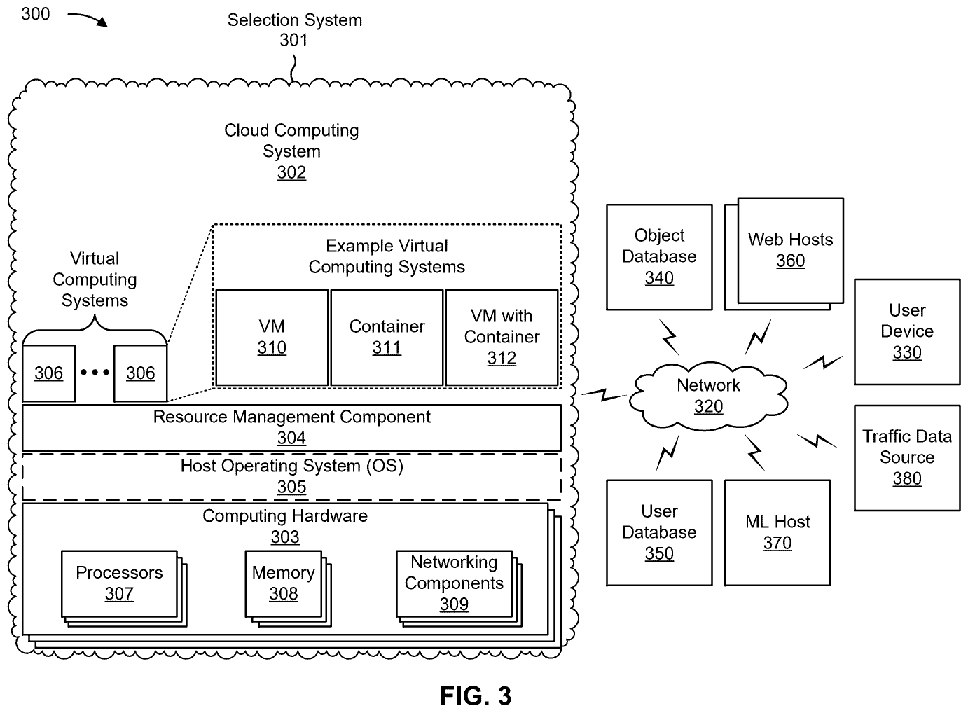

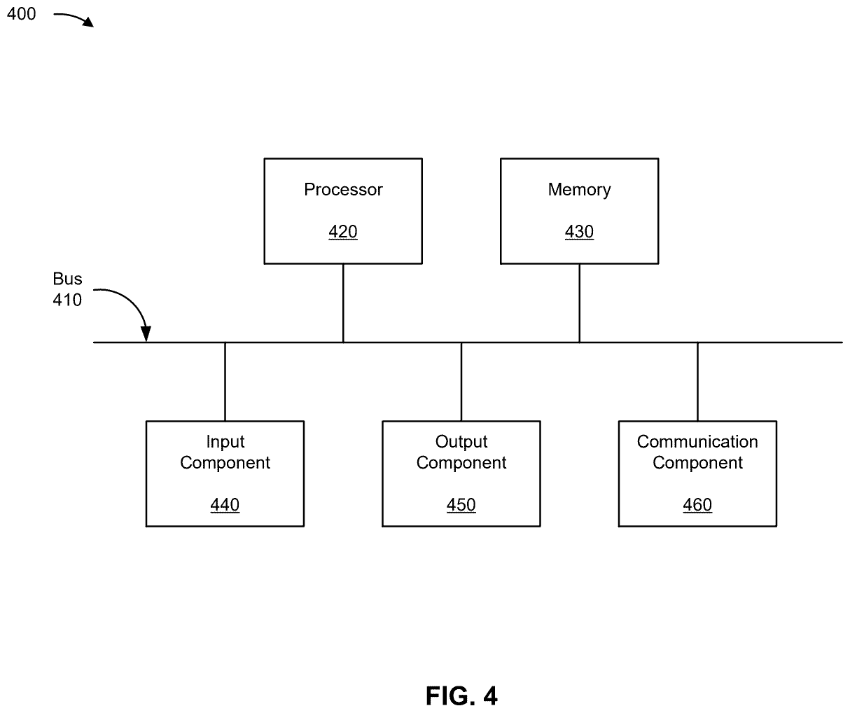

FIGS. 1A-1E are diagrams of an example 100 associated with machine learning for selecting from possible locations. As shown in FIGS. 1A-1E, example 100 includes a user device, a selection system, an object database, a user database, a set of web functions, a traffic data source, and a machine learning (ML) model (e.g., provided by an ML host). These devices are described in more detail in connection with FIGS. 3 and 4.

As shown in FIG. 1A and by reference number 105, the user device may transmit, and the selection system may receive, an indication of an object (e.g., at least one object). The indication may include a string description, a model number, a serial number, and/or another type of alphanumeric identifier associated with the object. In some implementations, the user device may capture (or otherwise receive) a scan of the object. For example, the user device may capture a universal product code (UPC) associated with the object and/or a picture of the object, among other examples. Accordingly, the indication may include the scan. Additionally, or alternatively, the indication may be based on the scan. For example, the user device may convert a scan of a UPC into a string representing the UPC, and the indication may include the string. In another example, the user device may apply a classifier (e.g., a machine learning model trained to classify objects) to a picture of the object, and the indication may include output from the classifier.

A user of the user device may trigger the user device to transmit the indication. For example, the user may provide input (e.g., using an input component of the user device) that triggers the user device to transmit the indication. In some implementations, the user device may output (e.g., using an output component of the user device) a user interface (UI), and the user may interact with the UI to provide the input. For example, the user device may output a webpage hosted by (or at least associated with) the selection system, and the user may interact with the webpage to provide the input. In another example, an application (also referred to as an “app” or “mobile app”) executed by the user device may generate the UI, and the user may interact with the UI of the application to provide the input.

In some implementations, the user device may transmit, and the selection system may receive, a request indicating the object. Therefore, the request may include the indication of the object. The request may include a hypertext transfer protocol (HTTP) request, a file transfer protocol (FTP) request, and/or an application programming interface (API) call, among other examples.

As shown by reference number 110, the selection system may determine a plurality of possible locations, associated with the object, using the object database. For example, the object database may transmit, and the selection system may receive, an indication of the plurality of possible locations. In some implementations, at least one of the plurality of possible locations is virtual (e.g., a website or another non-physical location); therefore, the indication may include a uniform resource locator (URL) and/or another identifier associated with the non-physical location. Additionally, or alternatively, at least one of the plurality of possible locations is physical (e.g., a building, such as a store, or another physical location); therefore, the indication may include an address (e.g., assigned by a postal service or another institution), a set of coordinates (e.g., using a geographic coordinate system (GCS) or another type of coordinate system), a store number, and/or another identifier associated with the physical location.

In some implementations, the selection system may transmit, and the object database may receive, a query indicating the object. For example, the query may be a structured query language (SQL) query, a NoSQL query, and/or another type of request for the object database (whether relational or non-relational). The query may indicate the object in a header and/or in an argument (e.g., using the indication of the object from the user device). In some implementations, the query may include an additional constraint (e.g., one or more additional constraints). For example, the additional constraint may be geographic (e.g., a zip code, a city, or another identifier of a geographic zone in which the plurality of possible locations should be). In another example, the additional constraint may be time-based (e.g., a day and/or a time during which the plurality of possible locations should be open for business). The object database may transmit, and the selection system may receive, a response to the query that indicates the plurality of possible locations. Therefore, the response may include the indication of the plurality of possible locations.

As shown in FIG. 1B and by reference number 115, the selection system may communicate with a first set of web functions, associated with the plurality of possible locations, to receive location information associated with the object. For example, the first set of web functions may transmit, and the selection system may receive, a first plurality of data structures representing the location information associated with the object. The location information may include inventory information (e.g., whether the object is in stock and/or how many of the object are in stock), sale information (e.g., pricing information and/or discount information), and/or shipping information (e.g., an estimated delivery date and/or an estimated delivery charge), among other examples. In some implementations, the first set of web functions may transmit, and the selection system may receive, the location information for each possible location in the plurality of possible locations. Alternatively, at least one web function in the first set may fail to respond and/or may respond with incomplete information.

In some implementations, the selection system may determine a set of endpoints (e.g., Internet protocol (IP) addresses, medium access control (MAC) addresses, and/or API function names, among other examples) associated with the first set of web functions based on the plurality of possible locations. For example, the selection system may map each possible location, in the plurality of possible locations, to an endpoint in the set of endpoints (e.g., using a data structure that stores indicators of possible locations in association with indicators of endpoints). Therefore, the selection system may transmit a request to a web function, in the first set of web functions, by transmitting the request to an endpoint, corresponding to the web function, in the set of endpoints. The selection system may receive a portion of the location information in response to the request. By transmitting requests for all endpoints, the selection system may receive the location information in response to the requests.

As shown by reference number 120a, the selection system may determine a plurality of possible accounts, associated with the user of the user device, using the user database. For example, the user database may transmit, and the selection system may receive, an indication of the plurality of possible accounts. The indication may include a plurality of string descriptions that correspond to the plurality of possible accounts, a plurality of account numbers that correspond to the plurality of possible accounts, and/or a set of credentials for each possible account in the plurality of possible accounts. The plurality of possible accounts may include a deposit account (e.g., a checking account, a debit card account, a savings account, a holding account, such as one at a brokerage, and/or a money market account, among other examples) or a credit account (e.g., a credit card account, a charge card account, a prepaid card account, and/or a credit line account, among other examples), among other examples.

In some implementations, the selection system may transmit, and the user database may receive, a query indicating the user. For example, the query may be an SQL query, a NoSQL query, and/or another type of request for the user database (whether relational or non-relational). The query may indicate the user in a header and/or in an argument (e.g., using the indication of the object from the user device). For example, the selection system may have received (e.g., from the user device, whether in the request described in connection with reference number 105 or separately, such as in a login request) an indication of the user (e.g., a username, a name, an email address, and/or a phone number, among other examples). Therefore, the selection system may include the indication of the user in the query. The user database may transmit, and the selection system may receive, a response to the query that indicates the plurality of possible accounts. Therefore, the response may include the indication of the plurality of possible accounts.

Additionally, or alternatively, as shown by reference number 120b, the user device may transmit, and the selection system may receive, the indication of the plurality of possible accounts. In some implementations, the user of the user device may trigger the user device to transmit the indication. For example, the user may provide input (e.g., using an input component of the user device) that triggers the user device to transmit the indication. In some implementations, the user device may output (e.g., using an output component of the user device) a UI, and the user may interact with the UI to provide the input. For example, the user device may receive instructions for the UI from the selection system, and the user may interact with the UI of the application to provide the input. Alternatively, the user device may transmit the indication automatically. For example, the selection system may transmit (and the user device may receive) a request for the plurality of possible accounts (e.g., in response to the request described in connection with reference number 105), and the user device may transmit (and the selection system may receive) the indication in response to the request from the selection system. The user device may retrieve the indication from a cache (or another type of local memory controlled by the user device) for transmission to the selection system. Although the example 100 shows the indication of the plurality of possible accounts being transmitted separately from the indication of the object, other examples may include a single message from the user device including both the indication of the plurality of possible accounts and the indication of the object.

In a combinatory example, the selection system may receive the indication of the plurality of possible accounts from the user database and may transmit a request to the user device for confirmation of the plurality of possible accounts. Accordingly, the user of the user device may confirm the plurality of possible accounts or may trigger the user device to transmit an indication of a change to the plurality of possible accounts (e.g., a new possible account to add, a possible account to remove, and/or a change to a possible account).

As shown in FIG. 1C and by reference number 125, the selection system may communicate with a second set of web functions, associated with the plurality of possible accounts, to receive terms associated with the plurality of possible accounts. For example, the second set of web functions may transmit, and the selection system may receive, a second plurality of data structures representing the terms associated with the plurality of possible accounts. The terms may include reward information (e.g., point accumulation information, point redemption information, and/or cash back information) and/or offer information (e.g., rewards specific to a possible location in the plurality of possible locations), among other examples. In some implementations, the second set of web functions may transmit, and the selection system may receive, the terms for each possible account in the plurality of possible accounts. Alternatively, at least one web function in the second set may fail to respond and/or may respond with incomplete information.

In some implementations, the selection system may determine a set of endpoints (e.g., IP addresses, MAC addresses, and/or API function names, among other examples) associated with the second set of web functions based on the plurality of possible accounts. For example, the selection system may map each possible account, in the plurality of possible accounts, to an endpoint in the set of endpoints (e.g., using a data structure that stores indicators of possible accounts in association with indicators of endpoints). Therefore, the selection system may transmit a request to a web function, in the second set of web functions, by transmitting the request to an endpoint, corresponding to the web function, in the set of endpoints. The selection system may receive a portion of the terms in response to the request. By transmitting requests for all endpoints, the selection system may receive the terms in response to the requests.

As shown by reference number 130, the user device may transmit, and the selection system may receive, an indication of a location. The location may be a current location associated with the user device or may be a starting location indicated by the user. In some implementations, the user of the user device may trigger the user device to transmit the indication. For example, the user may provide input (e.g., using an input component of the user device) that triggers the user device to transmit the indication. In some implementations, the user device may output (e.g., using an output component of the user device) a UI, and the user may interact with the UI to provide the input. For example, the user device may receive instructions for the UI from the selection system, and the user may interact with the UI of the application to provide the input. Alternatively, the user device may transmit the indication automatically. For example, the selection system may transmit (and the user device may receive) a request for the location (e.g., in response to the request described in connection with reference number 105), and the user device may transmit (and the selection system may receive) the indication in response to the request from the selection system. The user device may determine the location using a global positioning system (GPS) component or another type of global navigation satellite system (GNSS) component. Although the example 100 shows the indication of the location being transmitted separately from the indication of the object, other examples may include a single message from the user device including both the indication of the location and the indication of the object.

As shown by reference number 135, the traffic data source may transmit, and the selection system may receive, traffic information. The traffic information may be based on the location and the plurality of possible locations. For example, the traffic data source may estimate a set of routes between the location and each possible location in the plurality of possible locations. Therefore, the traffic information may be associated with the set of routes. For example, the traffic information may indicate estimated travel times, reported accidents, and/or road closures along the set of routes, among other examples.

In some implementations, the selection system may transmit, and the traffic data source may receive, a request for the traffic information (e.g., a query, an HTTP request, an FTP request, and/or an API call). Therefore, the data source may transmit, and the selection system may receive, traffic information in response to the request. In some implementations, the traffic information may be further based on a time associated with the request. For example, the traffic information may be recent based on the time being a current time, and the traffic information may be approximate based on the time being a future time. In some implementations, the time associated with the request is indicated in the request. For example, the user of the user device may input the time, and the user device may transmit an indication of the time with the location. Additionally, or alternatively, the time associated with the request may be a time at which the request is transmitted (by the selection system) and/or received (by the traffic data source).

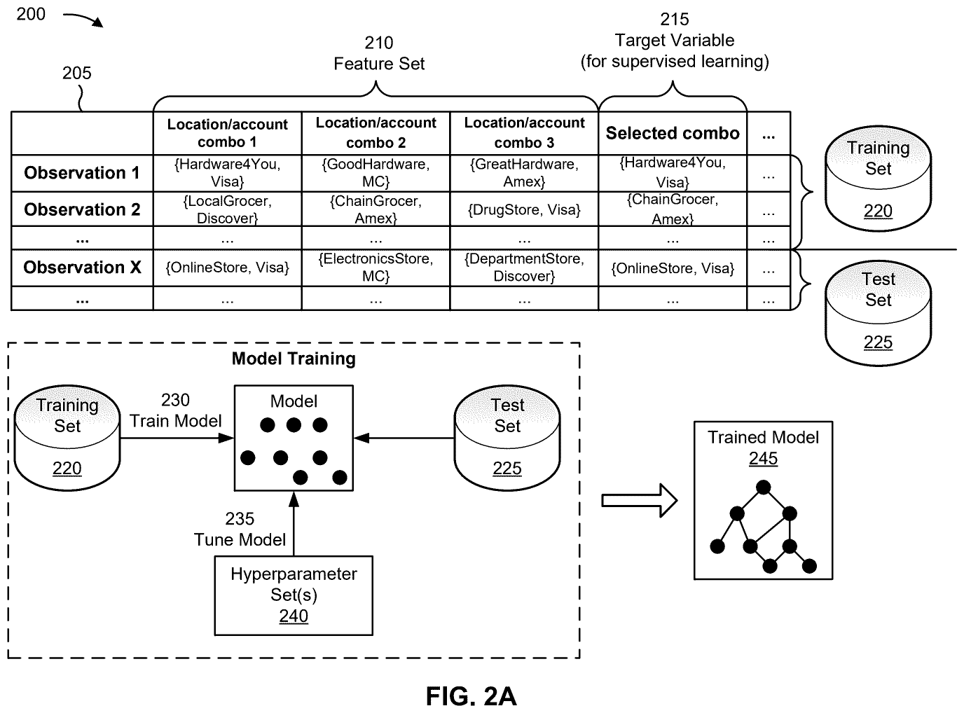

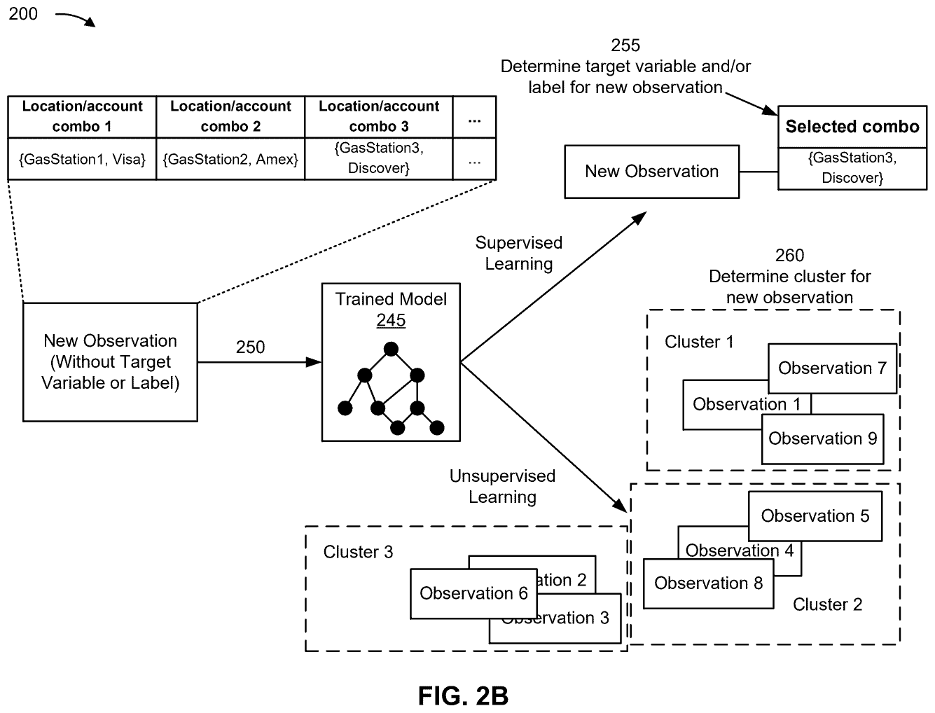

As shown in FIG. 1D and by reference number 140, the selection system may provide the location information associated with the object, the terms associated with the plurality of possible accounts, and the traffic information to the ML model. For example, the selection system may transmit the first plurality of data structures (encoding the location information), the second plurality of data structures (encoding the terms), and the traffic information (associated with the plurality of possible locations) to the ML host (associated with the ML model). The ML model may be trained and applied as described in connection with FIGS. 2A-2B. The ML model may be configured to minimize (at least locally) a holistic cost associated with the object. As used herein, “holistic cost” may refer to a cost calculated from a combination of monetary and non-monetary factors. For example, the ML model may calculate, for a combination of one of the plurality of possible locations and one of the plurality of possible accounts, a holistic cost based on a price (e.g., included in the location information), a reward (e.g., included in the terms), and a travel distance, time, and/or risk (e.g., based on the traffic information). Therefore, the ML model may select a particular combination from the plurality of possible locations and the plurality of possible accounts associated with a lowest holistic cost. By using a holistic cost, the ML model conserves power and processing resources as compared with using multiple models to select from the plurality of possible locations, to select from the plurality of possible accounts, and to use the traffic information (e.g., for routing). Additionally, the ML model is more accurate than separate models because the ML model uses a holistic cost.

As shown by reference number 145, the ML model may output an identifier of a selected location, from the plurality of possible locations, and an identifier of a selected account, from the plurality of possible accounts. For example, the ML host (associated with the ML model) may transmit, and the selection system may receive, the identifier of the selected location and the identifier of the selected account.

As shown in FIG. 1E, the selection system may output an indication of the selected location and an indication of the selected account. For example, as shown by reference number 150, the selection system may transmit, and the user device may receive, an indication of the selected location and the indication of the selected account. The indication of the selected location may include a name, a physical address, a set of coordinates, a map representing the selected location, information about a distance between the location from the user device and the selected location, and/or a URL, among other examples. The indication of the selected account may include a name, a (partial) account number, and/or a visual indicator (e.g., a logo of an issuing institution and/or a payment network associated with the selected account), among other examples. Therefore, the user device may output (e.g., using an output component of the user device) a UI representing the indications to the user.

Additionally, or alternatively, the selection system may transmit, and the user device may receive, the identifier of the selected location, from the plurality of possible locations, and the identifier of the selected account, from the plurality of possible accounts, based on application of the ML model using the indication of the object, the indication of the location, and the indication of the plurality of possible accounts. Because the selection system indicates both the selected location and the selected account to the user device, the user device conserves power and processing resources that otherwise would have been wasted on additional communications (e.g., with additional models) to determine an account after determining a location or to determine a location after determining an account. Additionally, because the selection system uses a singular model to determine both the selected location and the selected account, the user device receives more accurate information than if the user device were to request separate models to determine locations and accounts.

As shown by reference number 155, the user device may transmit, and the selection system may receive, an acceptance of the selected location. In some implementations, the user of the user device may trigger the user device to transmit the acceptance. For example, the user may provide input (e.g., using an input component of the user device) that triggers the user device to transmit the acceptance. In some implementations, the user may interact with the UI representing the indication of the selected location (and/or the indication of the selected account) to provide the input. For example, the user device may receive instructions for the UI from the selection system, and the user may interact with the UI of the application to provide the input.

Based on the acceptance, the selection system may output directions to the selected location (e.g., from the location provided by the user device). For example, as shown by reference number 160, the selection system may transmit, and the user device may receive, the directions. In some implementations, the selection system may communicate with a third-party API to provide the directions. For example, the selection system may communicate (and/or trigger the user device to communicate) with an API for Google® Maps, Waze®, or Apple® Maps, among other examples, in order to receive the directions from the third-party API.

Although the example 100 is described in connection with the selection system providing the directions, other examples may include the user device obtaining the directions. In one example, the user device may receive (e.g., using an input component of the user device) an interaction with the indication of the selected location and may output the directions to the selected location using a GPS application (or another type of GNSS application) executed by the user device. For example, the interaction may trigger execution of an application (e.g., associated with Google Maps, Waze, or Apple Maps, among other examples) that generates and outputs the directions to the user. In another example, the user device may receive (e.g., using an input component of the user device) an interaction with the indication of the selected location and may output a webpage associated with the selected location (and the object) using a web browser executed by the user device. For example, the selected location may be virtual, the indication of the selected location may include a URL, and the interaction may trigger execution of the web browser in order to navigate to the webpage based on the URL.

By using techniques as described in connection with FIGS. 1A-1E, ML model determines the selected location and the selection account for the object while using the traffic information as a factor. As a result, power and processing resources are conserved as compared with using separate models to select locations and accounts (and to route the user). Additionally, accuracy is increased by using the ML model as compared with using separate models.

As indicated above, FIGS. 1A-1E are provided as an example. Other examples may differ from what is described with regard to FIGS. 1A-1E.

FIGS. 2A-2B are diagrams illustrating an example 200 of training and using a machine learning model in connection with selecting from possible locations. The machine learning model training described herein may be performed using a machine learning system. The machine learning system may include or may be included in a computing device, a server, a cloud computing environment, or the like, such as a selection system and/or an ML host described in more detail below.

As shown in FIG. 2A and by reference number 205, a machine learning model may be trained using a set of observations. The set of observations may be obtained and/or input from training data (e.g., historical data), such as data gathered during one or more processes described herein. For example, the set of observations may include data gathered from an object database, a user database, and/or a traffic data source, as described elsewhere herein. In some implementations, the machine learning system may receive the set of observations (e.g., as input) from a user device (e.g., used by an administrator of the machine learning system).

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the user device. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of a first location and account combination, a second feature of a second location and account combination, a third feature of a third location and account combination, and so on. As shown, for a first observation, the first feature may have a value of a “Hardware4You” location in combination with a “Visa” account, the second feature may have a value of a “GoodHardware” location in combination with a Mastercard (“MC”) account, the third feature may have a value of a “GreatHardware” location in combination with an American Express (“Amex”) account, and so on. These features and feature values are provided as examples, and may differ in other examples. For example, the feature set may include one or more of the following features: locations, accounts, terms, objects, and/or traffic information, among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a selected location and account combination, which has a value of the Hardware4You location and the Visa account for the first observation.

The feature set and target variable described above are provided as examples, and other examples may differ from what is described above. Additionally, or alternatively, the machine learning system may filter the feature set. For example, the machine learning system may exclude any locations that are out of stock of an item (e.g., based on location information, as described in connection with FIG. 1A). In another example, the machine learning system may reject any combinations of locations and accounts that are incompatible (e.g., if a location does not accept credit cards or if a location only accepts some payment networks).

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that may include a first subset of observations, of the set of observations, and a test set 225 that may include a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm may include a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 2B.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

FIG. 2B illustrates applying the trained machine learning model 245 to a new observation. As shown by reference number 250, the machine learning system may receive a new observation (or a set of new observations), and may input the new observation to the trained machine learning model 245. As shown, the new observation may include a first feature of a “GasStation1” location and a “Visa” account, a second feature of a “GasStation2” location and an “Amex” account, a third feature of a “GasStation3” location and a “Discover” account, and so on, as an example. The machine learning system may apply the trained machine learning model 245 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 245 may predict a value of “GasStation3” and “Discover” for the target variable of selected combination of location and account for the new observation, as shown by reference number 255. Based on this prediction (e.g., based on the value having a particular label or classification or based on the value satisfying or failing to satisfy a threshold), the machine learning system may provide a recommendation and/or output for determination of a recommendation, such as an indication of the selected combination of location and account. Additionally, or alternatively, the machine learning system may perform an automated action and/or may cause an automated action to be performed (e.g., by instructing another device to perform the automated action), such as generating a UI representing the selected combination of location and account. As another example, if the machine learning system were to predict a value of “GasStation1” and “Visa” for the target variable of selected combination of location and account, then the machine learning system may provide a different recommendation (e.g., an indication of GasStation1 and Visa) and/or may perform or cause performance of a different automated action (e.g., generating a UI representing GasStation1 and Visa). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In some implementations, the trained machine learning model 245 may classify (e.g., cluster) different combinations in the new observation in clusters, as shown by reference number 260. The combinations within a cluster may have a threshold degree of similarity. As an example, if the machine learning system classifies a combination in a first cluster (e.g., associated with low holistic cost), then the machine learning system may provide a first recommendation, such as selecting that combination of location and account. Additionally, or alternatively, the machine learning system may perform a first automated action and/or may cause a first automated action to be performed (e.g., by instructing another device to perform the automated action) based on classifying the combination in the first cluster, such as generating a UI representing the combination. As another example, if the machine learning system were to classify the combination in a second cluster (e.g., associated with high holistic cost), then the machine learning system may provide a second (e.g., different) recommendation (e.g., selecting a different combination of location and account) and/or may perform or cause performance of a second (e.g., different) automated action, such as refraining from outputting an indication of that combination.

The recommendations, actions, and clusters described above are provided as examples, and other examples may differ from what is described above. For example, the machine learning model may instead output holistic costs associated with each combination of location and account. Therefore, the machine learning system may select the combination associated with a lowest holistic cost as determined by the machine learning model.

In this way, the machine learning system may apply a rigorous and automated process to selecting a location and an account for an object. The machine learning system may enable increased accuracy by using a combination of terms (for the accounts) and traffic information (for the locations) to minimize (at least locally) a holistic cost. Additionally, the machine learning system may conserve power and processing resources as compared with applying separate models to determine locations and accounts.

As indicated above, FIGS. 2A-2B are provided as an example. Other examples may differ from what is described in connection with FIGS. 2A-2B. For example, the machine learning model may be trained using a different process than what is described in connection with FIG. 2A. Additionally, or alternatively, the machine learning model may employ a different machine learning algorithm than what is described in connection with FIGS. 2A-2B, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram of an example environment 300 in which systems and/or methods described herein may be implemented. As shown in FIG. 3, environment 300 may include a selection system 301, which may include one or more elements of and/or may execute within a cloud computing system 302. The cloud computing system 302 may include one or more elements 303-312, as described in more detail below. As further shown in FIG. 3, environment 300 may include a network 320, a user device 330, an object database 340, a user database 350, a set of web hosts 360, an ML host 370, and/or a traffic data source 380. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the selection system 301 may include one or more elements 303-312 of the cloud computing system 302, may execute within the cloud computing system 302, and/or may be hosted within the cloud computing system 302, in some implementations, the selection system 301 may not be cloud-based (e.g., may be implemented outside of a cloud computing system) or may be partially cloud-based. For example, the selection system 301 may include one or more devices that are not part of the cloud computing system 302, such as device 400 of FIG. 4, which may include a standalone server or another type of computing device. The selection system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with indications (e.g., of objects, accounts, and/or locations), as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The object database 340 may be implemented using one or more devices capable of receiving, generating, storing, processing, and/or providing information associated with objects, as described elsewhere herein. The object database 340 may be implemented using a communication device and/or a computing device. For example, the object database 340 may be implemented using a server, a database server, an application server, a client server, a web server, a host server, a proxy server, a virtual server (e.g., executing on computing hardware), a server in a cloud computing system, a device that includes computing hardware used in a cloud computing environment, or a similar type of device. The object database 340 may communicate with one or more other devices of environment 300, as described elsewhere herein.

The user database 350 may be implemented using one or more devices capable of receiving, generating, storing, processing, and/or providing information associated with accounts, as described elsewhere herein. The user database 350 may be implemented using a communication device and/or a computing device. For example, the user database 350 may be implemented using a server, a database server, an application server, a client server, a web server, a host server, a proxy server, a virtual server (e.g., executing on computing hardware), a server in a cloud computing system, a device that includes computing hardware used in a cloud computing environment, or a similar type of device. The user database 350 may communicate with one or more other devices of environment 300, as described elsewhere herein.

The set of web hosts 360 may include one or more devices capable of receiving, generating, storing, processing, providing, and/or routing information associated with objects and/or accounts, as described elsewhere herein. The set of web hosts 360 may provision a set of web functions (e.g., a set of APIs). The set of web hosts 360 may include a communication device and/or a computing device. For example, the set of web hosts 360 may include a server, such as an application server, a client server, a web server, a database server, a host server, a proxy server, a virtual server (e.g., executing on computing hardware), or a server in a cloud computing system. In some implementations, the set of web hosts 360 may include computing hardware used in a cloud computing environment. The set of web hosts 360 may communicate with one or more other devices of environment 300, as described elsewhere herein.

The ML host 370 may include one or more devices capable of receiving, generating, storing, processing, and/or providing information associated with machine learning models, as described elsewhere herein. The ML host 370 may include a communication device and/or a computing device. For example, the ML host 370 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 370 may communicate with one or more other devices of environment 300, as described elsewhere herein.

The traffic data source 380 may include one or more devices capable of receiving, generating, storing, processing, and/or providing traffic information, as described elsewhere herein. The traffic data source 380 may further provide a routing service between locations. The traffic data source 380 may include a communication device and/or a computing device. For example, the traffic data source 380 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The traffic data source 380 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with machine learning for selecting from possible locations. The device 400 may correspond to a user device 330, a device providing an object database 340, a device providing a user database 350, a web host 360, an ML host 370, and/or a traffic data source 380. In some implementations, a user device 330, a device providing an object database 340, a device providing a user database 350, a web host 360, an ML host 370, and/or a traffic data source 380 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

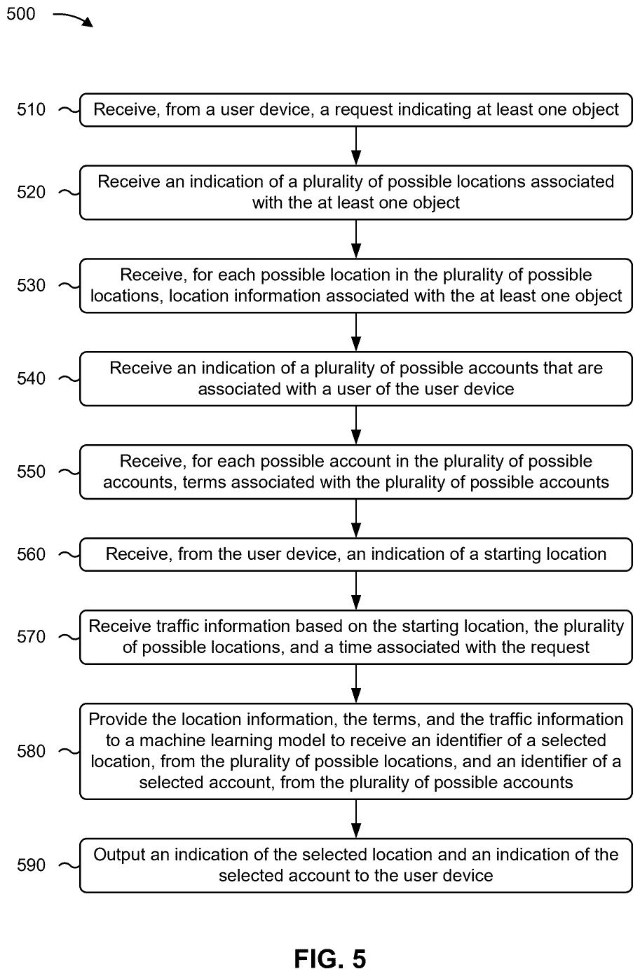

FIG. 5 is a flowchart of an example process 500 associated with applying machine learning for selecting from possible locations. In some implementations, one or more process blocks of FIG. 5 may be performed by a selection system 301. In some implementations, one or more process blocks of FIG. 5 may be performed by another device or a group of devices separate from or including the selection system 301, such as a user device 330, a device providing an object database 340, a device providing a user database 350, a web host 360, an ML host 370, and/or a traffic data source 380. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a request indicating at least one object (block 510). For example, the selection system 301 (e.g., using processor 420, memory 430, and/or communication component 460) may receive, from a user device, a request indicating at least one object, as described above in connection with reference number 105 of FIG. 1A. As an example, the indication may include a string description, a model number, a serial number, and/or another type of alphanumeric identifier associated with the at least one object. In some implementations, the indication may include (or at least be based on) a scan of the at least one object.

As further shown in FIG. 5, process 500 may include receiving an indication of a plurality of possible locations associated with the at least one object (block 520). For example, the selection system 301 (e.g., using processor 420, memory 430, and/or communication component 460) may receive an indication of a plurality of possible locations associated with the at least one object, as described above in connection with reference number 110 of FIG. 1A. As an example, the selection system 301 may transmit a query indicating the at least one object to an object database, and the selection system 301 may receive a response, including the indication of the plurality of possible locations, from the object database in response to the query.

As further shown in FIG. 5, process 500 may include receiving, for each possible location in the plurality of possible locations, location information associated with the at least one object (block 530). For example, the selection system 301 (e.g., using processor 420, memory 430, and/or communication component 460) may receive, for each possible location in the plurality of possible locations, location information associated with the at least one object, as described above in connection with reference number 115 of FIG. 1B. As an example, the selection system 301 may transmit requests to a set of web functions associated with the plurality of possible locations, and the selection system 301 may receive the location information in response to the requests.

As further shown in FIG. 5, process 500 may include receiving an indication of a plurality of possible accounts that are associated with a user of the user device (block 540). For example, the selection system 301 (e.g., using processor 420, memory 430, and/or communication component 460) may receive an indication of a plurality of possible accounts that are associated with a user of the user device, as described above in connection with reference number 120a or reference number 120b of FIG. 1B. As an example, the selection system 301 may transmit a query indicating the user to a user database, and the selection system 301 may receive a response, including the indication of the plurality of possible accounts, from the user database in response to the query. As another example, the selection system 301 may receive the indication of the plurality of possible accounts from the user device (e.g., with the indication of the at least one object or separately).

As further shown in FIG. 5, process 500 may include receiving, for each possible account in the plurality of possible accounts, terms associated with the plurality of possible accounts (block 550). For example, the selection system 301 (e.g., using processor 420, memory 430, and/or communication component 460) may receive, for each possible account in the plurality of possible accounts, terms associated with the plurality of possible accounts, as described above in connection with reference number 125 of FIG. 1C. As an example, the selection system 301 may transmit requests to a set of web functions associated with the plurality of possible accounts, and the selection system 301 may receive the terms in response to the requests.

As further shown in FIG. 5, process 500 may include receiving, from the user device, an indication of a starting location (block 560). For example, the selection system 301 (e.g., using processor 420, memory 430, and/or communication component 460) may receive, from the user device, an indication of a starting location, as described above in connection with reference number 130 of FIG. 1C. As an example, the indication of the starting location may include an address (e.g., assigned by a postal service or another institution), a set of coordinates (e.g., using a GCS or another type of coordinate system), and/or another similar identifier of the starting location.

As further shown in FIG. 5, process 500 may include receiving traffic information based on the starting location, the plurality of possible locations, and a time associated with the request (block 570). For example, the selection system 301 (e.g., using processor 420, memory 430, and/or communication component 460) may receive traffic information based on the starting location, the plurality of possible locations, and a time associated with the request, as described above in connection with reference number 135 of FIG. 1C. As an example, the selection system 301 may transmit a request, to a traffic data source, indicating the starting location, the plurality of possible locations, and the time, and the selection system 301 may receive the traffic information from the traffic data source in response to the request.

As further shown in FIG. 5, process 500 may include providing the location information, the terms, and the traffic information to a machine learning model to receive an identifier of a selected location, from the plurality of possible locations, and an identifier of a selected account, from the plurality of possible accounts (block 580). For example, the selection system 301 (e.g., using processor 420, memory 430, and/or communication component 460) may provide the location information, the terms, and the traffic information to a machine learning model to receive an identifier of a selected location, from the plurality of possible locations, and an identifier of a selected account, from the plurality of possible accounts, as described above in connection with FIG. 1D. As an example, the machine learning model may be trained and applied as described in connection with FIGS. 2A-2B. In some implementations, the selection system 301 may transmit the location information, the terms, and the traffic information to an ML host associated with the machine learning model, and the selection system 301 may receive the identifiers from the ML host.

As further shown in FIG. 5, process 500 may include outputting an indication of the selected location and an indication of the selected account to the user device (block 590). For example, the selection system 301 (e.g., using processor 420, memory 430, and/or communication component 460) may output an indication of the selected location and an indication of the selected account to the user device, as described above in connection with reference number 150 of FIG. 1E. As an example, the indication of the selected location may include a name, a physical address, a set of coordinates, a map representing the selected location, information about a distance between the location from the user device and the selected location, and/or a URL, among other examples. Additionally, the indication of the selected account may include a name, a (partial) account number, and/or a visual indicator (e.g., a logo of an issuing institution and/or a payment network associated with the selected account), among other examples.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

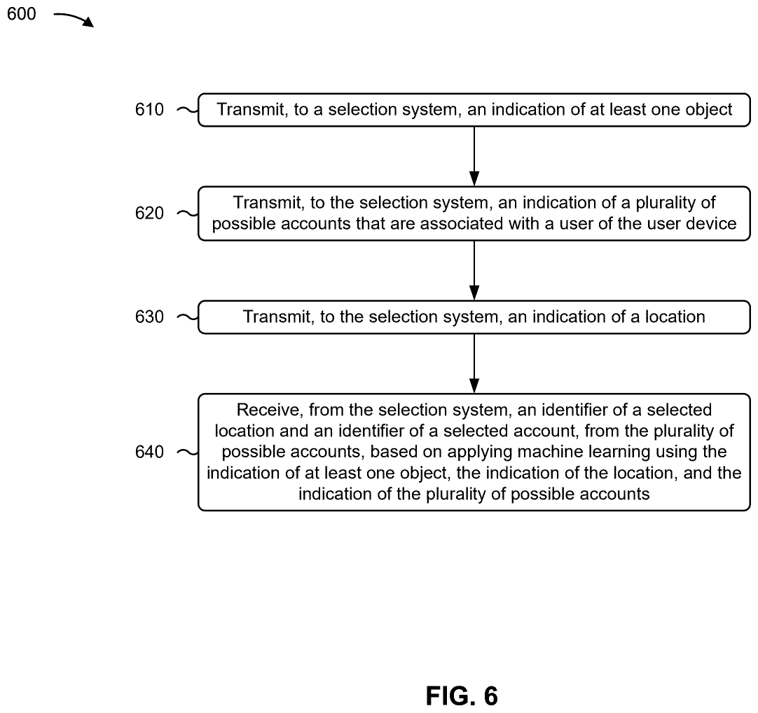

FIG. 6 is a flowchart of an example process 600 associated with using machine learning for selecting from possible locations. In some implementations, one or more process blocks of FIG. 6 may be performed by a user device 330. In some implementations, one or more process blocks of FIG. 6 may be performed by another device or a group of devices separate from or including the user device 330, such as a selection system 301, a device providing an object database 340, a device providing a user database 350, a web host 360, an ML host 370, and/or a traffic data source 380. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a selection system, an indication of at least one object (block 610). For example, the user device 330 (e.g., using processor 420, memory 430, and/or communication component 460) may transmit, to a selection system, an indication of at least one object, as described above in connection with reference number 105 of FIG. 1A. As an example, a user of the user device 330 may trigger the user device 330 to transmit the indication. For example, the user may provide input (e.g., using an input component 440 of the user device 330) that triggers the user device 330 to transmit the indication. In some implementations, the user device 330 may output (e.g., using an output component 450 of the user device 330) a UI, and the user may interact with the UI to provide the input.

As further shown in FIG. 6, process 600 may include transmitting, to the selection system, an indication of a plurality of possible accounts that are associated with a user of the user device (block 620). For example, the user device 330 (e.g., using processor 420, memory 430, and/or communication component 460) may transmit, to the selection system, an indication of a plurality of possible accounts that are associated with a user of the user device, as described above in connection with reference number 120b of FIG. 1B. As an example, the user may provide input (e.g., using an input component 440 of the user device 330) that triggers the user device 330 to transmit the indication. In some implementations, the user device 330 may output (e.g., using an output component 450 of the user device 330) a UI, and the user may interact with the UI to provide the input. As another example, the user device 330 may transmit the indication automatically. For example, the user device 330 may receive a request for the plurality of possible accounts from the selection system, and the user device 330 may transmit the indication to the selection system in response to the request. The user device 330 may retrieve the indication from a cache (e.g., memory 430) for transmission to the selection system.

As further shown in FIG. 6, process 600 may include transmitting, to the selection system, an indication of a location (block 630). For example, the user device 330 (e.g., using processor 420, memory 430, and/or communication component 460) may transmit, to the selection system, an indication of a location, as described above in connection with reference number 130 of FIG. 1C. As an example, the user may provide input (e.g., using an input component 440 of the user device 330) that triggers the user device 330 to transmit the indication of the location. In some implementations, the user device 330 may output (e.g., using an output component 450 of the user device 330) a UI, and the user may interact with the UI to provide the input. As another example, the user device 330 may transmit the indication of the location automatically. For example, the user device 330 may receive a request for the location from the selection system, and the user device 330 may transmit the indication of the location to the selection system in response to the request. The user device 330 may determine the location using a GPS component or another type of GNSS component.

As further shown in FIG. 6, process 600 may include receiving, from the selection system, an identifier of a selected location, from the plurality of possible locations, and an identifier of a selected account, from the plurality of possible accounts, based on application of machine learning using the indication of at least one object, the indication of the location, and the indication of the plurality of possible accounts (block 640). For example, the user device 330 (e.g., using processor 420, memory 430, and/or communication component 460) may receive, from the selection system, an identifier of a selected location, from the plurality of possible locations, and an identifier of a selected account, from the plurality of possible accounts, based on application of machine learning using the indication of at least one object, the indication of the location, and the indication of the plurality of possible accounts, as described above in connection with reference number 150 of FIG. 1E. As an example, the user device 330 may receive an indication of the selected location, which may include a name, a physical address, a set of coordinates, a map representing the selected location, information about a distance between the location from the user device and the selected location, and/or a URL, among other examples. Additionally, the user device 330 may receive an indication of the selected account, which may include a name, a (partial) account number, and/or a visual indicator (e.g., a logo of an issuing institution and/or a payment network associated with the selected account), among other examples. Therefore, the user device may output (e.g., using an output component 450 of the user device 330) a UI representing the indications to the user.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for using machine learning to select from a plurality of possible locations, the system comprising:
one or more memories; and
one or more processors, communicatively coupled to the one or more memories, configured to:
receive, from a user device, an indication of at least one object;
determine, using an object database, the plurality of possible locations, wherein the plurality of possible locations are associated with the at least one object;
communicate with a first set of web functions, associated with the plurality of possible locations, to receive a first plurality of data structures representing location information associated with the at least one object;
determine, using a user database, a plurality of possible accounts that are associated with a user of the user device;
communicate with a second set of web functions, associated with the plurality of possible accounts, to receive a second plurality of data structures representing terms associated with the plurality of possible accounts;
receive, from the user device, an indication of a current location associated with the user device;
transmit, to a traffic data source, a request for traffic information based on the current location and the plurality of possible locations;
receive, from the traffic data source, the traffic information in response to the request;
provide the first plurality of data structures, the second plurality of data structures, and the traffic information to a machine learning model to receive a particular location and account pairing from the plurality of possible locations and the plurality of possible accounts,
wherein the particular location and account pairing includes an identifier of a selected location and an identifier of a selected account,
wherein the machine learning model is trained using feature sets of location and account pairings, and
wherein the machine learning model is configured to filter the feature sets by rejecting location and account pairings that are incompatible;
output an indication of the selected location and an indication of the selected account to the user device;
receive, from the user device, an acceptance of the selected location; and
output, to the user device, directions to the selected location from the current location.

2. The system of claim 1,
wherein the indication of the at least one object comprises a scan of the at least one object.

3. The system of claim 1,
wherein the one or more processors, to determine the plurality of possible locations, are configured to:
transmit, to the object database, a query indicating the at least one object; and
receive, from the object database, a response to the query that indicates the plurality of possible locations.

4. The system of claim 1,
wherein the one or more processors are configured to:
determine a set of endpoints associated with the first set of web functions, based on the plurality of possible locations,
wherein the set of endpoints are used to communicate with the first set of web functions.

5. The system of claim 1,
wherein the machine learning model is configured to minimize a holistic cost associated with the at least one object.

6. The system of claim 1,
wherein at least one of the plurality of possible locations is virtual.

7. The system of claim 1,
wherein the one or more processors are configured to:
communicate with a third-party application programming interface to receive the directions.

8. A method of using machine learning to select from a plurality of possible locations, comprising:
transmitting, from a user device and to a selection system, an indication of at least one object;
transmitting, from the user device and to the selection system, an indication of a plurality of possible accounts that are associated with a user of the user device;
transmitting, from the user device and to the selection system, an indication of a location; and
receiving, from the selection system and at the user device, a particular location and account pairing from the plurality of possible locations and the plurality of possible accounts, based on application of machine learning using the indication of at least one object, the indication of the location, and the indication of the plurality of possible accounts,
wherein the particular location and account pairing includes an identifier of a selected location and an identifier of a selected account, and
wherein the machine learning is trained using feature sets of location and account pairings.

9. The method of claim 8, further comprising:
capturing, by the user device, a scan of the at least one object,
wherein the indication of the at least one object is based on the scan.

10. The method of claim 8,
wherein transmitting the indication of the plurality of possible accounts comprises:
transmitting a plurality of string descriptions that correspond to the plurality of possible accounts.

11. The method of claim 8,
wherein transmitting the indication of the plurality of possible accounts comprises:
transmitting a plurality of account numbers that correspond to the plurality of possible accounts.

12. The method of claim 8, further comprising:
transmitting, for each possible account in the plurality of possible accounts, a set of credentials for the possible account.

13. The method of claim 8,
wherein the selected location is virtual, and the method further comprises:
receiving an interaction with an indication of the selected location; and
outputting, using a web browser executed by the user device, a webpage associated with the selected location and the at least one object.

14. The method of claim 8,
wherein the selected location is physical, and the method further comprises:
receiving an interaction with an indication of the selected location; and
outputting, using a global position system application executed by the user device, directions to the selected location.

15. A non-transitory computer-readable medium storing a set of instructions for using machine learning to select from a plurality of possible locations, the set of instructions comprising:
one or more instructions that, when executed by one or more processors of a device, cause the device to:
receive, from a user device, a request indicating at least one object;
receive an indication of the plurality of possible locations, wherein the plurality of possible locations are associated with the at least one object;
receive, for each possible location in the plurality of possible locations, location information associated with the at least one object;
receive an indication of a plurality of possible accounts that are associated with a user of the user device;
receive, for each possible account in the plurality of possible accounts, terms associated with the plurality of possible accounts;
receive, from the user device, an indication of a starting location;
receive traffic information based on the starting location, the plurality of possible locations, and a time associated with the request;
provide the location information, the terms, and the traffic information to a machine learning model to receive a particular location and account pairing from the plurality of possible locations and the plurality of possible accounts,
wherein the particular location and account pairing includes an identifier of a selected location and an identifier of a selected account, and
wherein the machine learning model is trained using feature sets of location and account pairings; and
output an indication of the selected location and an indication of the selected account to the user device.

16. The non-transitory computer-readable medium of claim 15,
wherein the selected location is virtual, and the indication of the selected location comprises a uniform resource locator.

17. The non-transitory computer-readable medium of claim 15,
wherein the indication of the selected account comprises a visual indicator associated with the selected account.

18. The non-transitory computer-readable medium of claim 15,
wherein the one or more instructions, that cause the device to receive the indication of the plurality of possible accounts, cause the device to:
transmit, to a user database, a query including an identifier associated with the user; and
receive, from the user database, a response to the query including the indication of the plurality of possible accounts.

19. The non-transitory computer-readable medium of claim 15,
wherein the indication of the starting location comprises a physical address or a set of coordinates.

20. The non-transitory computer-readable medium of claim 15,
wherein the time associated with the request is indicated in the request.
